(19) United States
(12) Patent Application Publication
(10) Pub. No.: US 2007/0119950 A1
(43) Pub. Date: May 31, 2007

(54) Document edge encoding using multi-spectral encoding tags

(76) Inventors: Judith D. Auslander, Westport, CT (US); Robert A. Cordery, Danbury, CT (US); Bertrand Haas, New Haven, CT (US)

Correspondence Address: Pitney Bowes Inc.;Intellectual Property and Technology Law Dept., 35 Waterview Drive, P.O. Box 3000, Shelton, CT, 06484, US

(21) Appl. No.: 11/290,729

(22) Filed: Nov. 30, 2005

(51) Int. Cl. G06K 7/00; G06K 19/06

(52) U.S. Cl. 235/486; 235/491

(57) ABSTRACT

A document including a substrate and an information marking printed on the substrate. The substrate has a front side, a rear side and a perimeter side edge. The perimeter side edge has a substantially smaller size than the front side and the rear side. The information marking is printed on the perimeter side edge of the substrate. The information marking includes multi-spectral encoding tags adapted to be read in a direction towards the perimeter side edge.

### BACKGROUND OF THE INVENTION

1. Field of the Invention

The invention relates to a document having encoded information and, more particularly, to an edge of a document having the encoded information.

2. Brief Description of Prior Developments

Encoding with barcodes (one or two dimensional) requires a relatively large area on a flat piece of paper. Therefore, to read a barcode this area must be visible to the scanner. This prohibits the scanning of barcodes directly from a stack of paper or documents. Each sheet or document has to be uncovered (at least partly) so that the barcode can be read.

Mailers and postal services print barcodes on envelopes or labels attached to mail pieces. The barcodes are used to provide information related to processing the mail piece. A POSTNET code, provided by the mailer or consolidator, provides destination address information to the postal service sorters. A PLANET code printed by the mailer is a request to provide simple feedback when a mail piece is processed. Linear barcodes printed on mail pieces must be isolated from each other and from other printed matter on the mail piece. Mail carriers scan bar code labels attached to mail pieces by mailers when they request value-added services such as delivery confirmation. These labels tend to be large and can obscure other information on mail pieces.

Postal services print a mail piece identifier using a lightly colored fluorescent bar code known as a postal-ID tag. The postal-ID tag fluoresces in a broad wavelength band in the orange region and can be excited with broad band ultraviolet light. The fluorescent emission of paper on the mail piece, such as that produced by optical brighteners used in paper manufacturing, and the fluorescence of the postal ID tag, have broad overlapping spectral features, the postal sorter's detection system can be confused. In some cases the fluorescent signal of the ID tags may be diminished by the interfering fluorescence of the optical brighteners.

Postage meters can print indicia with two-dimensional barcodes that provide postage payment evidence. The indicium barcode can include value-added service requests. The provider of that value-added service would have to read every barcode to find the ones that actually request service.

Color barcodes are known, such as the barcode disclosed in U.S. Pat. No. 6,793,138, that increase the information density of printed barcodes. The broad absorption band of the individual colors limits the increase in information density to about three to five times the density of a monochrome code. If several colors are printed in one area, it is difficult to distinguish the different colors. One of the earliest implementation of color barcodes is on small electronic resistors to encode resistance value.

Similar to the use of color, spectral mixtures of fluorescent dyes can increase information density. The dyes have broad emission spectra and a wide range of excitation wavelengths varying from short UV to visible. They also often have a small Stokes shift; i.e., difference between the excitation wavelength and emission wavelength. These properties conspire to make the detection systems more costly and complicated. As in the case of color barcodes, since there are strong overlaps between the emission bands of various fluorescent dyes, the increase in information density is limited. Invisible barcodes are known that can be either luminescent or infrared absorbing. They can be printed over visible information without obscuring the visible information. The known invisible bar codes also have broad spectral features.

All of the symbols and inks described above suffer a common limitation because they are printed with inks that have broad overlapping spectral features. The symbols must, therefore, be printed on different regions of the envelope. Parties participating in the mail stream process suffer the problems of printing symbols without interfering with information that is already there. As an example, consider the POSTNET barcode that identifies the delivery point. A mailer may print an incorrect POSTNET code and deliver the mail piece to a consolidator. The consolidator may print a new barcode, correcting the POSTNET to agree with the address, in the space reserved for higher priority POSTNET codes along the bottom edge of the envelope. The postal service may realize that the recipient has moved and want to print a new POSTNET for the forwarding address. Unfortunately, there is no space assigned for this third POSTNET code. Typically the post follows the inconvenient and obtrusive process of placing a label with the new code over the existing POSTNET code.

“UPU/CEN Mail Communication System Reference Model: General Concepts and Entity Relationship Model”, Draft Version 2.1. Sep. 12, 2005, which is hereby incorporated by reference in its entirety, describes the parties and processes that take part in a mail process. There are multiple applications for communicating via bar codes on the envelopes. The inks used in postal applications typically have broad emission and absorption spectra. The spectra overlap and interfere with each other. Due to the limited area of the envelope the postal service issues regulations that define the required placement of bar codes, clear zones and other information on a mail piece. The resulting mail piece can be cluttered and confusing.

Limited amounts of information can be encoded in the bar codes due to the use of monochromatic inks (black or other colors) and broadband single channel reflectance-based contrast. Readability is dependent on print contrast, which requires high loading of colorant, causing reliability issues for inks. Postal applications need high-density information to enable services, mail piece identification, and postage cryptographic evidencing. Because there are a large number of information fields on the mail piece, there is a strong dependence on registration, printing sequence, and positioning for postal processing of high volumes of mail.

Hand-held scanners lack precise orientation and positioning. Typically each application, on a document having multiple bar codes, uses a separate type of bar code to help with identifying which bar code is for which purpose.

Conventional bar codes are obtrusive, taking a large space on the envelope and making it difficult to see additional information such as ad slogans, addresses, etc. It can be difficult to find a particular bar code and distinguish its signal from the other information.

The limited information capacity of envelopes, and the static nature of information on envelopes gives rise to a need for a database linked to the mail piece information. Maintaining and providing remote access to this database can be expensive.

The ease of copying postage indicium barcodes means that it is necessary to detect duplicates based on the information recovered from duplicate mail pieces. Achieving a high duplicate detection rate means that most mail pieces should be scanned and information related to the mail pieces recorded in a duplicates database. The resulting complex infrastructure adds to the cost of the postal process. Previous security inks such as those described in U.S. Patent Application Publication No. 2005/0040234 (Euchner/Auslander) describes printing indicia with ink characteristics such as color and luminescence of mixtures of organic fluorescent dyes. These are all very low-resolution characteristics with overlapping reflectance or luminescence spectra.

Inks with narrow band fluorescence spectra use fluorescent nanoparticle quantum dots or rare earth-doped nanoparticles. Suitable rare earth-doped nanoparticles for incorporating in an ink are described in “Rare earth-doped doped glass microbarcodes” by Matthew J. Dejneka et al. Evident Technologies manufactures inks for anti-counterfeiting using semi-conducting quantum dots. The use of quantum dots in inks to provide high information density in very small spots has been described in “Information coding and retrieving using fluorescent semiconductor nanocrystals for object identification” by Shoude Chang, et al. in 12 Jan. 2004/Vol. 12, No. 1/OPTICS EXPRESS pg 143. The fluorescent nanoparticle inks described by Barbera-Guillem of BioCrystal, Ltd. in U.S. Pat. Nos. 6,835,326 and 6,576,155 use only the fluorescent characteristics, but not the phosphorescence of the rare earth oxides as additional parameters (for example the decay time). Barbera-Guillem further uses excitation wavelength for the rare earth oxides above 300 nm. The encoded information is limited because they use only monochrome emission wavelength modules in the encoded data without using their combined wavelength in fixed ratio. The comparison of the encoded data to a database such as described in U.S. Patent Application Publication No. 2004/0241424 can be cumbersome and involves handling of a lot of data that is not suitable for a postal application.

Principals participating in the mail generation and distribution process would like to provide information downstream to aid in correct processing of a mail item. There are many such players, and they frequently use bar codes to communicate. Using multiple barcodes results in several problems. The mail item becomes very busy and unattractive. There is confusion in identifying the correct information, so that the postal service must place labels over superceded information. The lack of space on the mail item makes aligning on a clear area difficult. Possible services or corrections are simply not introduced because of the difficulties mentioned.

### SUMMARY OF THE INVENTION

In accordance with one aspect of the invention, a document is provided including a substrate and an information marking printed on the substrate. The substrate has a front side, a rear side and a perimeter side edge. The perimeter side edge has a substantially smaller size than the front side and the rear side. The information marking is printed on the perimeter side edge of the substrate. The information marking includes multi-spectral encoding tags adapted to be read in a direction towards the perimeter side edge.

In accordance with another aspect of the invention, a document container assembly is provided comprising a document container and a plurality of documents. The document container comprises a bottom with a window section. The plurality of documents are located in the document container. Each document comprises a substrate having a side edge located against a top side of the bottom of the document container, and an information marking printed on the side edge of the substrate. The information marking comprises multi-spectral encoding tags. The documents are arranged in the document container such that the information markings of the plurality of documents can be read at a substantially same time through the window section.

In accordance with another aspect of the invention, a bound document is provided comprising a plurality of document pages connected to each other and information markings. Each page comprising a substrate and indicium printed on the substrate. Each substrate comprises a first side edge which combine to form a first side of the bound document when the bound document is in a closed configuration. The information markings are printed on the first side edges of the substrates. The information markings comprises multi-spectral encoding tags.

In accordance with one method of the invention, a method for encoding information is provided comprising orienting a document with a side edge of a substrate of the document at least partially facing towards a printer; and printing an information marking on the side edge of the substrate by the printer, wherein the information marking comprises multi-spectral encoding tags.

### BRIEF DESCRIPTION OF THE DRAWINGS

The foregoing aspects and other features of the invention are explained in the following description, taken in connection with the accompanying drawings, wherein:

FIG. 1 is a plan view of a mail piece comprising features of the invention;

FIG. 2 is a perspective view of the mail piece shown in FIG. 1 showing the bottom side of the mail piece;

FIG. 3 is an enlarged view of a portion of the bottom side of the mail piece shown in FIG. 2;

FIG. 4 is an enlarged view of a portion of the bottom side of an alternate embodiment of the invention;

FIG. 5 is a perspective view of a document container assembly comprising a document container and documents located in the document container;

FIG. 6 is a bottom plan view of the document container assembly shown in FIG. 5;

FIG. 7 is a perspective view of a document container assembly comprising a hanging file folder document container and documents located in the document container;

FIG. 8 is a bottom plan view of the document container assembly shown in FIG. 7;

FIG. 9 is a perspective view of a book comprising features of the invention;

FIG. 10 is a side view of the book shown in FIG. 9; and

FIG. 11 is an illustration of a system for reading an information marking of the invention.

### DETAILED DESCRIPTION OF THE PREFERRED EMBODIMENTS

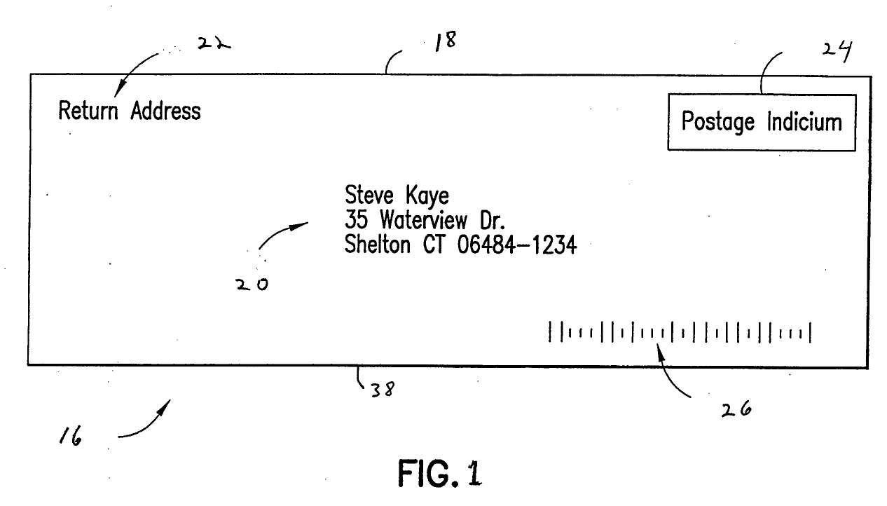

Referring to FIG. 1, there is shown a plan view of a document 16 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

The document 16, in this example, is a mail piece. More specifically, the mail piece includes an envelope, but the marking could be provided on any suitable document or substrate. The mail piece 16 comprises a substrate 18 and various postal markings such as a delivery address marking 20, a return address marking 22, a postage indicium 24 and a POSTNET bar code 26. Additional or alternative markings could be provided.

Printing of a postage indicium with a color metameric ink, for example luminescent ink such as a fluorescent ink or a phosphorescent ink, is described in U.S. patent application Ser. No. 10/692,569 filed Oct. 24, 2003, which is hereby incorporated by reference in its entirety. The definition of a metameric ink used herein includes inks that can have different characteristics under certain conditions versus the ink's color under ambient lighting. Dark color fluorescent inks (e.g., dual luminescent) are described in U.S. Pat. Nos. 6,827,769; and 6,793,723; and U.S. patent application publication Nos. US 2002/0195586 A1, US 2003/0005303 A1, and US 2003/0041774 A1, which are hereby incorporated by reference in their entireties. U.S. patent application Ser. No. 10/692,570, which is hereby incorporated by reference in its entirety, describes halftone printing and gray scale printing with multi-signal transmission ink. U.S. Pat. No. 5,153,418 discloses multiple resolution machine readable symbols.

The invention can use spectral encoded tags, and methods for producing such tags, for communicating between parties in a multi-party process. This is described in commonly owned, co-pending U.S. Patent Application No. TBA, entitled Ink Jet Inks Having Taggants for Providing Physical Encoding for Data and Security Applications, filed concurrently herewith (Attorney Docket No. F-948) which is hereby incorporated by reference in it entirety. In particular the invention can use spectral encoded tags employing a set of narrow-band luminescent taggants such as quantum dots in a carrier, such as ink for example. The carrier with the taggants can be printed on a substrate or document to form a marking or a sub-component of a marking.

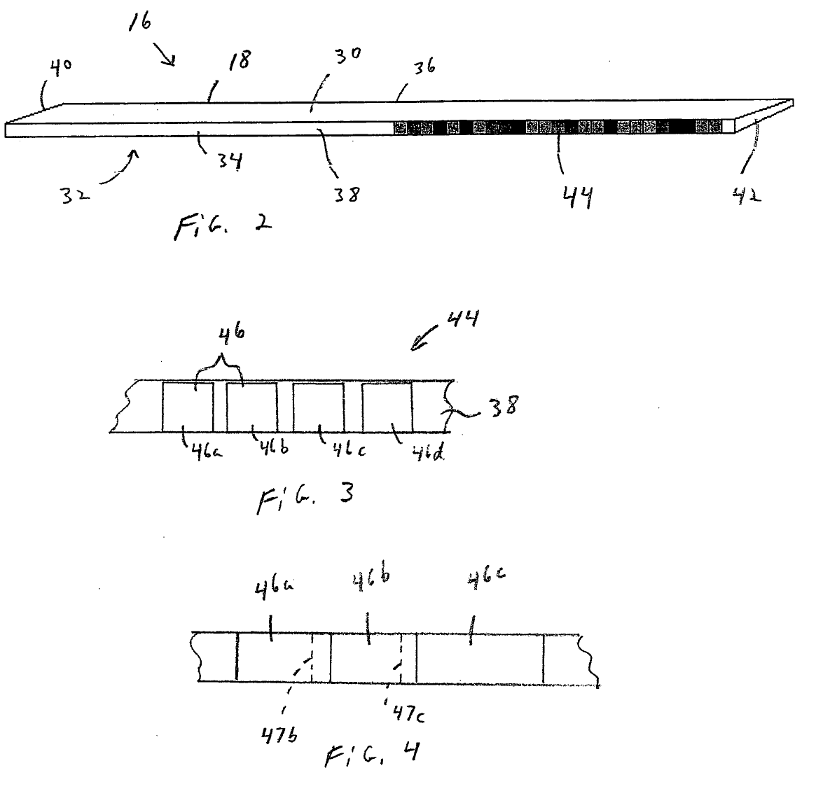

Referring also to FIG. 2, the substrate 18 comprises a front side 30, a rear side 32, and a perimeter side edge 34. The indicia 20, 22, 24, 26 are printed on the front side 30. The substrate 18 comprises a folded and glued piece of paper to form the envelope, but could comprise folded cardboard or plastic for example. The folded substrate 18 forms a top side 36, a bottom side 38, and two end sides 40, 42 at the folds or joints between the front and rear sides 30, 32. The front and rear sides form the major sides of the document 16 and are substantially larger than the top side 36, bottom side 38, and two end sides 40, 42.

As seen in FIG. 2, the bottom side or edge 38 of the substrate has an indicium 44 printed thereon. In this embodiment the indicium comprises a Multi-Spectral Encoded Tag (MSET). A MSET is an image that contains multiple separately detectable luminescent particles or taggants such as rare earth complexes, oxides, embedded in silica matrix nanoparticles, etc. or semiconductor quantum dots. The luminescent particles can be manufactured or separated into multiple groups such that each group can be excited in a narrow bandwidth referred to as an MSET channel. In other words, each wavelength band for each different taggant is called an MSET channel. The groups can be selected so that the excited emission bands of the different MSET channels are spaced or have minimal overlap in wavelength.

Referring also to FIG. 3, an enlarged view of a portion of the indicium 44 is shown. The indicium 44 comprises multiple MSET channels which, in the embodiment shown, are arranged in a one dimensional bar code format as individual blocks 46. More specifically, the blocks 46 each comprise ink printed on the bottom edge 38 of the substrate. The ink for each block comprises a carrier and one or more luminescent taggants. The blocks 46 are printed with multiple different inks. The different inks each have at least one different luminescent taggant from each other. In its simplest form, each ink can comprise only one respective luminescent taggant. However, one or more of the inks could comprise more than one luminescent taggant. The carrier(s) could comprise a single color ink, an invisible ink, or multiple respectively different color inks for example. In this embodiment, the blocks 46a, 46b, 46c, 46d, etc. each have a different taggant.

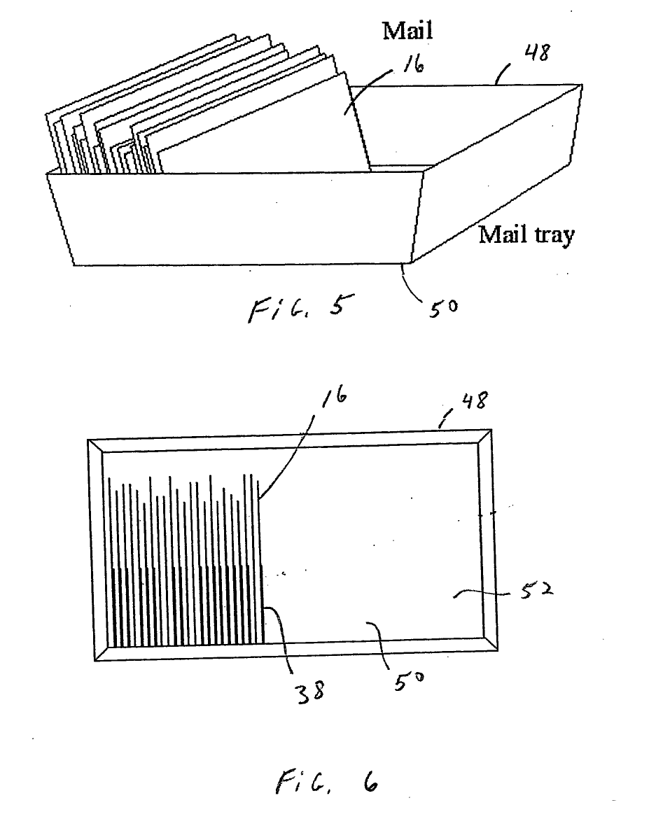

Preferably, the MSET channels in the blocks 46 do not interfere with each other when printed in the same location or closely adjacent location. For example, FIG. 4 shows an embodiment where the blocks 46a, 46b, and 46c were printed in overlapping positions. Edge 47b of block 46b is located underneath block 46a. Edge 47c of block 46c is located underneath block 46b. The taggants can be printed overlapping each other without blocking the excitation signature from excited overlapped markings. Thus, a MSET overcomes the difficulty with physical overlap of symbols noted above in the prior art. Printing with the use of quantum dots excited indiscriminately by a broad UV light (250-400 nm) removes the need for masking by using UV absorbers because the ink carrying the taggants can be printed overlapping each other without blocking the excitation signature from excited quantum dots in the overlapped markings.

In an alternate embodiment, rather than a single block 46 made from a single module, each block could be comprised of a plurality of modules arranged in a one-dimensional or two-dimensional bar code configuration. The actual modules would preferably be printed solid with an ink or carrier containing an appropriate narrow band group luminescent nanoparticles. The spectral encoded tags disclosed herein can luminesce in narrow wavelength bands. An application, such as mail distribution, can define a set of wavelength bands with little wavelength overlap for the different taggants.

The nanoparticles may be of a varied nature and include, but are not limited to, quantum dots, luminescent semiconductor nanoparticles and rare earth dopes glass beads, as described in further detail below. The wavelength and intensity spectral attributes of these nanoparticles due to their defined, narrow, multiple frequencies can be used to encode information. Thus, according to an embodiment of the invention, a MSET is a combination of different luminescent nanotaggants with unique different spectral features. The total number of possible MSETs is the number of distinguishable intensity levels raised to the power of the number of distinguishable nanotaggants. For examples, a MSET with 10 taggants and three distinguishable levels has 59000 values or approximately 16 bits. The amount of encoded data will increase as the number of distinguishable taggants and levels increases. This technology can be used for variable data printing for document security, object identification and tracking.

The advantages of this technology when compared with 1D or 2D bar codes, which needs space to arrange the ordered data, is that multi-spectral encoding can increase the density of the information by more than an order of magnitude. The information can be invisible to the naked eye. Alternatively, the fluorescent multispectral encoding can use colored inks so that an observer can see that the information is printed. Preferably, inks are lightly colored with print reflectance difference less than 0.5 so that fluorescence is not quenched. Bar codes which are sequence (1D) or pixel (registration) dependent (2D) are rotation and position dependent and, therefore, often require bulky and complex decoders and readers. The subject MSET can be detected with a fluorospectrophotometer through simple fiber optics connections. Due to the high fluorescent intensity of the quantum dots (no self quenching occurs such as in the organic dyes case) only a small amount of nanotaggant, for example, about 1 weight percent is needed to create a high contrast signal.

As noted above, several categories of nanoparticles can be used for multispectral encoding. For example, quantum dots are semiconductor nanocrystals of about 2-20 nm and are selected from groups IIB and VIA, such as CdSe (cadmium selenide), CdS (cadmium sulfide), ZnSe (zinc selenide), etc. The fluorescence frequency is size dependent as, for example, CdSe particles of 2.8 nm show green fluorescence, while 5.6 nm show red fluorescence. These semiconductor nanoparticles such as CdSe, ZnSe, InAs, PbSe, etc. and combinations thereof emit light based on the electron confinement in particles with a radius less than about 10 nm. Thus, these particles also may be referred to as quantum dots, which are nanosized semiconductor crystals having a diameter between about 2 and about 10 nm, with each size quantum dot corresponding to a given emission peak. Quantum confinement of both the electron and hole in all three dimensions leads to an increase in the effective band gap of the material with decreasing crystallite size. Consequently, both the optical absorption and emission of quantum dots shift to the blue (higher energies) as the size of the dots become smaller.

The particles are monodispersed and the narrow size distribution allows the possibility of light emission in very narrow spectral widths. These small particles may be conventionally produced in an organic solvent with capping agents for colloid stabilization, such as trioctylphosphine, etc. These particles have a quantum yield of about 30-50% and emit narrow emissions characteristic to their size and band gap. Nanoparticles can be classified into groups that, for example, fluoresce in one of the narrow bands. Each group can, for instance, emit one of 15-30 discrete fluorescent emission wavelengths that can be detected separately which advantageously results in a considerable number of combinations. The ratio between the various emissions can be changed in a predictable way and large numbers of patterns can be created. These nanoparticles can be stabilized with non-ionic surfactants and dispersed in water. They are generally excited by broad band incident light in the visible or ultraviolet range.

Another suitable type of nanoparticles includes microglass beads doped with rare earth ions excitable at short wave UV excitation of about of about 240 nm to less than about 300 nm, such as about 254 nm, or long wave UV excitation of about 320 to 380 nm. The glass beads may include rare earth ions such as Tb, Dy, Eu, Y, Pr, etc. in predetermined patterns or combinations or can be homogeneous with one rare earth element per bead. The beads are inert and can be dispersed in any carrier without interfering with the physical properties of the ink, as well as not changing the characteristics of the formulation. A particularly useful type of rare earth doped microglass bead includes a silica matrix for a stable fluorescent signal.

Rare earth-doped nanoparticles are ideal fluorescent taggants for ink as, for example, rare earth-doped glasses fluoresce in narrow emission bands. This allows a large amount of information to be encoded. They have high quantum efficiencies, thus, converting a large number of the absorbed incident shorter wavelength light to longer wavelength emissions in a narrow band. Because they are isolated by the glass, other components of the ink do not easily quench their fluorescence. These particles are also inert to most organic and aqueous solvents and thus can typically be added to any ink. They are non-reactive and, thus, do not attack materials of the printer. See Dejneka et al., Proceedings of the National Academy of Sciences of the United States (PNAS), Jan. 21, 2003, vol. 100, no. 2, 389-393. Moreover, the glass beads excitable at the afore-referenced long wave UV excitations are even more difficult to counterfeit than those excitable at shorter wave UV excitations as the long wave UV excitations are very narrow as described in the following reference “Novel Security System Based On Rare Earth Doped Glass Microbeads” by Simon Officer et al., The Robert Gordon University, Aberdeen, AB 10 1FR, UK, Optical Document Security conference, Proceedings of SPIE, 2004, pg. The foregoing microglass beads are micrometer-sized glass beads that can contain a pattern of different fluorescent materials easily identifiable by using a UV lamp and fluorospectrophotometer.

The nanotaggants can be delivered to any desired substrate, such as an envelope, etc., by ink carriers and preferably by digital inks, such as ink jet fluids. By preparing different inks either with one type of nanotaggant (for example, green) or with a predetermined combination of nanotaggants, various mixtures can be delivered to the substrate and information encoded accordingly.

As the nanotaggants can be used in the inks at very low concentrations (e.g. between about 0.5 and about 4 wt. %, typically about 1 wt. %, which is much less than in colored inks with contrast necessary for readability) very small drops in printing (e.g. less than about 1-2 pL) can be employed. By using multiple channel printers, as used for photorealistic applications, the MSETs can be delivered on a very small area on the substrate at a high speed without concern for positioning, satelliting or surface compliance. The spectral information can depend only on wavelength and intensity. This can present a huge advantage for delivering machine readable information at high speeds with modern ink jet technology designed for photorealistic printing.

Accordingly, the nanotaggents comprising the afore-described nanoparticles may be employed as markers in ink. For example, they may be employed in jet inks for ink jet drop on demand technology. The desired type of nanoparticles may be combined with traditional ink formulation constituents to create an ink having a specialized marking and encoding system built therein. See also, commonly owned, co-pending U.S. patent application Ser. No. 11/267,002 (attorney docket No. F-938) describing fluorescent inks with special signature using rare earth complexes, the contents of which are hereby incorporated by reference.

An example of one type of suitable carrier for the MSET is now described. It is noted that this represents merely one example for illustration purposes only and any other desired ink/carrier may be employed. Thus, according to one embodiment, the ink may also comprise an aqueous liquid vehicle comprising water and a water soluble organic vehicle in sufficient amounts to achieve an ink viscosity and surface tension effective for application of the ink jet ink to a substrate in a predetermined pattern by ink jet printing. Water is desirable as the main solvent due to the large number of plastic materials used for ink jet printer parts. Water may typically be present in an amount between about 50 and about 90 weight percent, although other suitable amounts may be employed. Organic solvents may be employed, but they have to be tested for compatibility since some organic based solvents may attack the plastic materials and interfere with the proper functioning of the parts. Other ink components commonly used in ink jet inks are: surfactants, binders, viscosity modifiers, humectants, penetrants, etc. as described in commonly owned, co-pending U.S. patent application Ser. No. 11/267,002 (Attorney Docket No. F-938).

The ink viscosity and surface tension of the ink jet ink should be such that it is effective for application of the ink jet ink to a substrate in a predetermined pattern by ink jet printing. For example the viscosity of the ink jet ink for use in some piezoelectric ink jet printers may be between about 1 and about 20 cps, and may be lower for thermal ink jet printers, such as between about 1 and about 5 cps. A desirable surface tension of the ink jet ink may be between about 30 and about 50 dynes/cm.

The weight percent of the nanoparticles in the ink formulation may vary, but typically may be from about 0.5 to about 4 weight percent of the formulation, and preferably about 1 weight percent. Other constituents may be employed within the ink formulations, such as those disclosed in U.S. Pat. Nos. 6,005,002, 5,674,314 and 5,919,846, 6,793,723 and U.S. Publication Number 2003/0005303A1, which are hereby incorporated by reference. Moreover, inks including the afore-described nanotaggants may be made by any suitable method known in the art for producing inks.

Accordingly, the afore-described nanotaggents may be employed as markers in ink jet drop on demand technology. For example, by mixing nanotaggants in various combinations using a carrier fluid, a high number of numerical combinations and, thus, unique codes (e.g. based on emission spectra comprising color and/or intensity) in real time may be achieved.

Bar codes may be created with the use of these nanotaggants and can be assigned in real time to, for example, one large customer (batches of mail) or to smaller batches, as well as to individual pieces of mails. The shape, position and orientation of these bar codes are advantageously not critical for the parsing and readability of the information, as described above.

Bar codes may be produced employing a variety of fluorescing nanoparticles such as the afore-referenced microglass beads, quantum dots and/or rare earth doped glass particles. These particles fluoresce in a narrow band controlled in part by the size and shape of the particle, such as a narrow bandwidth of about only 30 nm for example. The nanoparticles may be sorted into groups that fluoresce in a narrow band. These narrow band fluorescent nanoparticles or nanotaggants are suitable for addition to carriers such as inks used to produce bar codes. This narrow bandwidth can allow high spectral resolution and also allow physical overlapping markings without substantially interfering with the reading of the markings.

Because the nanotaggants do not interfere with each other, each of the bar codes can be read separately using a multispectral imager with narrow bandpass filters (<30 nm) which can image all of the bar codes separately at the same time. Alternatively, separate single channel imagers can each read only one of the distinguishable bands. If the separate imagers are at one place, or a multispectral imager is employed, a large amount of data can be read at one time.

Additionally, information transmitted to the Post using fluorescent nanotaggants can be hidden in image. Layered bar codes with two levels (present or absent) for each nanotaggant can be hidden in a grayscale or color image. That would make indicia unobtrusive, which makes it more attractive from a user standpoint. For example, in the MSETs shown in FIG. 4, both the first information marking 46a and the second information marking 46b could be printed with the same color ink as the carrier, but have different luminescent taggants with different and preferably spaced luminescence wavelength bands. However, one or both of the sub-component markings 46a, 46b could comprise an invisible ink carrier.

A further benefit is that, because the bar code for each sub-component fluoresces strongly in a narrow band, it will appear very bright compared to the background and, thus, easy to detect and locate. An additional advantage is that there may be multiple bar codes that are each individually detectable.

Moreover, multiple, discriminating codes with different functions at different times and locations on the same “real estate” with black ink can constitute a problem for readability, involve limitations in processing, and can be obtrusive visually and cause confusion. The foregoing can solve these problems, as described above. Further advantages include security against interception of information and duplication, forensic features are also advantageously provided and the product code may be changed on demand. Moreover, information can be captured reliably under adverse conditions and a high density of information may be stored.

Benefits of fluorescence include encoding from, for example, 8 to 32 different inks (1 to 4 bytes per module). Multiple messages can be encoded in the same area using different inks without masking each other. A further example of the foregoing application can be the formation of a secure network of carriers, which can be certified to use the encoding system described herein. This is particularly advantageous as the scanning and verification may often be completed in less than ideal conditions and the robustness of spectral encoding (reading of spectral characteristics on the substrates) can considerably improve the read rate of portable scanners.

The nanotaggants described herein also may advantageously be detected with specialized array detectors or cameras with narrow filters that can identify these complex luminescence patterns and authenticate the codes.

Printing of a marking with the invention can include many different possibilities. The following are some examples:
Printing a single marking with a single ink having multiple different taggants;
Printing a combined marking having at lease two markings as sub-components to form the combined marking;
Printing multiple markings (each with at least one of its own separate different taggant) spatially separate from each other;
Printing multiple markings (each with at least one of its own separate different taggant) spatially on top of each other; (overlapping)
and combinations of these.

These are only some examples. Different MSET channels can also be printed at about the same time by a same printer or at different times and with different printers, such as by different entities for example. However, even if printed at different times and with different printers, such as by different entities, the different MSET channels can be printed in a same space (at least partially overlapping) without interfering with subsequent reading of any one of the MSET channels. In addition, besides using wavelength to encode information, signal intensity can be used in addition to or as an alternative to wavelength encoding. The taggants in the markings could be different as well as using different concentrations of taggants printed by the printer to communicate additional information using multiple concentration levels. Thus, both wavelength and signal intensity could be used to provide an even greater number of MSET channels.

An originator's printer might only comprise a single ink having a taggant. However, if the originator's printer is capable of printing multiple inks each having one or more different taggants, than printing can comprise selection of the different types of inks. The printer or a computer can comprise software to select which types of ink to use. For example, a user's person computer could comprise a software plug-in. The selection of the ink(s) could be determined based upon which service is requested for example. Spatial combinations of the taggant containing inks could also be determined by the software, such as an algorithm or look-up table for example, based upon a requested service or perhaps for error correction or redundancy of the normal daylight visible information. These are only some examples. Other variations should be obvious after reading the present description.

There are a variety of fluorescing nanoparticles such as quantum dots or rare earth doped glass particles. These particles fluoresce in a narrow band controlled in part by the size and shape of the particle. It is known to sort quantum dots into groups that fluoresce in a narrow band. These narrow-band fluorescent nanoparticles are suitable for addition to carriers such as ink jet inks and will be referred to generally as nanotaggants. N_{c} printer channels can be supplied with different types of ink including nanotaggants such that each type of ink fluoresces in a different, distinguishable band when excited with broadband UV or visible light, where C is an integer and N represents a printer channel, such as printer channels N₁, N₂, N₃, etc.

The N_{c} channels can be used to provide increased information density in a printed symbology. As an example, if the basic symbology is a barcode, a symbol can be printed that includes N_{c} barcodes printed over the same area. Each of the barcodes is printed with one of the inks and, thus, fluoresces in one of the narrow bands. While we refer here to barcodes, other symbologies can be employed including text characters, watermarks, glyphs, multilevel codes that associate different values with different intensities, or any other symbology. The symbology printed with each of the inks can be different.

A multi-channel printer can provide the N_{c} channels, thus, increasing the amount of information that can be printed in a given area at one time. Alternatively, multiple printers can be employed to apply the N_{c} inks, possibly at different times. For example in the mail production process, the originator of the mail piece can print information about the purpose of the mail piece, the level of service required can be printed using a second ink. The postage meter can read the level of service required and print postage evidence using a third ink. The postal processing system can print sortation instructions using a fourth ink and the carrier can print delivery information using a fifth ink. An advantage of the invention is that each barcode is imaged separately, so it is not necessary to accurately align the separate barcodes. This greatly simplifies the production process, because the print does not require a prior scanning to determine the correct location.

Because the nanotaggants do not interfere with each other, each of the barcodes can be read separately using a multispectral imager. The imager can image all of the barcodes separately at the same time. Alternatively, separate single channel imagers can each read only one of the distinguishable bands. If the separate imagers are at one place, or a multispectral imager is employed, a large amount of data can be read at one time.

While the preferred form for an information marking is a barcode, the term “information marking” includes text, linear barcodes, 2D barcodes, OCR fonts, watermarks, dataglyphs, any icon image, or simply the presence of a luminescent emission in a narrow band. Further, the term “information marking” includes a grayscale code where information is encoded in the level of fluorescent emissions from each region of the information marking. For example, an information marking could include a code employing four levels where the levels are an absence of emission, low level emission, mid-level emission and maximum level emission which encodes two bits per region. The preferred mode of printing is ink jet. However, printing includes any method of placing the luminescent taggants such as electrophotgraphy, dry or liquid toners, thermal transfer, or dye diffusion for example.

Reading by luminescence can comprise distinguishing the emissions from the narrow band luminescence from background luminescence and from other MSET channels, detecting an image in the narrow band luminescent emissions, and extracting data from image. “Distinguishably luminescently readable” means that, through the use of a suitable optical bandpass filter for example, the first information marking can be read using the luminescent emissions of the first luminescent taggants, independent of the presence of the second luminescent emissions.

Referring back to FIG. 2, the invention utilizes the feature in multi-spectral encoding tags (MSET) that allows very compact encoding to encode information on the edges of a document. A stack of documents (as long as they don't hide each other's edge) can then have this information scanned all at once instead of document by document.

Information can be encoded and printed on the edge of an envelope, or a file folder, or a page with a set of inks containing quantum dots or other narrow band fluorescent materials. The encode information can be read by a scanner that can see the printed edge. Information can be read from a document without singulating the document, thus providing advantages in document management.

The wavelength and intensity spectral attributes of luminescent (fluorescent or phosphorescent) “quantum dots”, luminescent semiconductor nanoparticles and rare earth doped glass beads due to their defined, narrow, multiple frequencies are used to encode information. A multi-spectral encoded tag (MSET) consists in modules that are a combination of different luminescent nanotaggants with unique spectral features. The total number of possible values for each module is the number of distinguishable intensity levels raised to the power of the number of distinguishable nanotaggants. For instance an MSET with ten taggants and three distinguishable levels has 3¹⁰ (or 59049) values or approximately 16 bits. Such an MSET module (16 bits) compares advantageously with a black and white barcode module or only 1 bit.

The MSET can be detected with a fluorospectrophotometer through simple fiber optics connections. Only a small amount of taggant is needed to create a high contrast signal. The nanotaggants can be delivered to the substrates by ink carriers and preferably by digital inks as for example ink jet fluids. By preparing different inks either with one type of nanotaggant or with a predetermined combination of them, various mixtures can be delivered to the substrate. The nanotaggants can be used in the inks in very low concentrations (−1%); much less than is necessary for sufficient readability in colored inks. We can alternatively use very small drops (<1-2 pL). By using multiple channel printers, as used for photorealistic applications, we can deliver the MSETs on a very small area on the substrate at high speed without worrying about positioning, satelliting, or surface compliance. Because of the small amount of space required for an MSET relative to the information it carries, the MSETs can be printed on the edges of a document. Several instances of applications that can greatly benefit from such edge encoding include, for example,:
Postal application;
Document folder application; and
Book application.

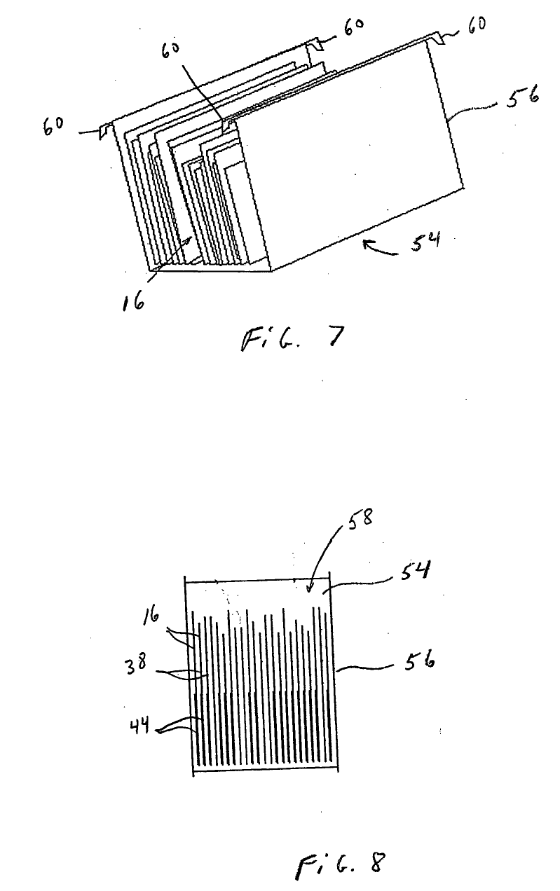

For a postal application, some information (in particular all the information currently contained or encoded in one or more of the indicia 20, 22, 24, 26) can be encoded on the edge of the mail piece 16. For example, the information marking could comprise mail piece postal information comprising postage value information, address information, sender information, etc. The modules of the marking 44 could also combine to form a unified spatial information visible in normal daylight. Referring also to FIGS. 5 and 6, in a preferred embodiment the bottom edge 38 is at the bottom side of the mail piece such that the bottom side can be placed against the bottom of a mail tray 48. The mail tray 48 has a bottom side 50 and an open top. The bottom side 50 in this embodiment has a document viewing window 52. In this embodiment the window 52 comprises a transparent bottom section in the bottom side 48. By gravity, the bottom edges of mail pieces are in contact with the transparent tray bottom 48. Consequently, the bottom edges are all at the same level, and mail pieces cannot hide edges of neighboring mail pieces. The content of a tray can then be scanned from the bottom of the tray. This would allow a processing of mail pieces all at once and avoid individual manipulations.

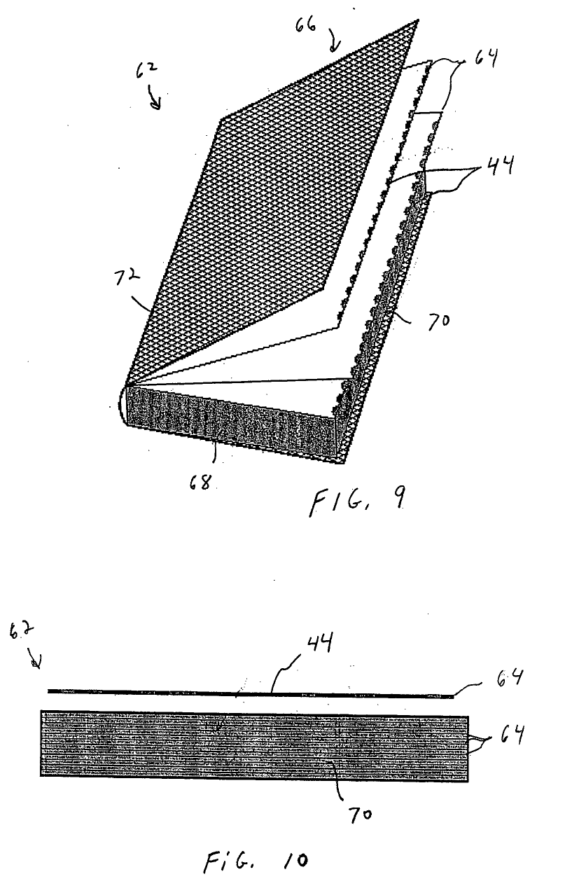

Referring now to FIGS. 7 and 8, in the document folder application meta-data about physical documents 16 (their type, time of print, author, etc.) can be encoded on the edge 38 facing down in a folder 56. For greater flexibility, the same data can be encoded on both the top and bottom edges of the documents 16. The documents could comprise, for example, two sided or three sided folders, papers, medical charts, X-rays, etc. One or more of the documents 16 in the folder 56 have an information marking 44 on the edge 38. The folder 56 in this embodiment is a hanging folder having tabs 60 to hang the folder on a support. However, in alternate embodiments any suitable type of folder support could be provide. The bottom 54 of the folder 56 has a window 58. In this embodiment, the window is provided by the bottom of the folder 56 being transparent. When the documents 16 are placed in the folder 56, they are placed against the top side of the window 58 and held against the window by gravity. The contents of the folder 56 can be scanned from the bottom of the folder. In other words, the information markings 44 for all the documents 16 in the folder 56 can be read at a same time by merely scanning the information markings 44 through the window 58. This would greatly increase the efficiency of document search and retrieval. The MSET channels in the blocks or modules of the information markings 44 are configured such that they do not interfere with each other during reading. Because of the different narrow band luminescence wavelengths of the different taggants, the MSET channels can be read independently or separately distinguished from each other during reading.

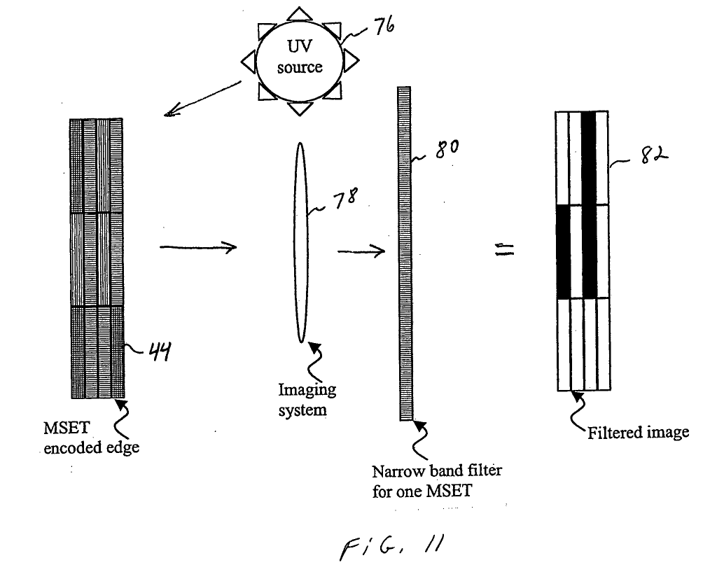

Referring now to FIGS. 9 and 10, in the book application individual pages 64 of a bound document 62, such as a book or manual, can have data encoded on edges of the pages. The excellent alignment of the edges of the pages, perpendicularly to an end of the bound document when closed, make it possible to scan the data of all the pages at once on one of the sides of the bound document (top side 66, bottom side 68, and/or free side 70). In the embodiment shown the edges of the pages at the free side 70 of the bound document are printed with individual information markings. The near perfect alignment of the pages in the direction parallel to the bound edge 72 of the book, allows for more efficient encoding. This alignment and the consistency of the edge length also allow encoding on the entire length of the edges 70. Therefore, a greater amount of data can be encoded. In particular, the content of a page is often naturally (for a human reader) split into a part with low enough complexity, like plain English text, and the remaining part which may comprise complicated formulas, diagrams or images. The content of lower complexity can be entire encoded on one or more of the edges 66-70. This would be a great advantage, for example, for online book sellers, such as Amazon.com, who want to publish a sample of the book online. For another example, it could be used to quickly download the content of a book on a computer for more thorough research using searching tools, cut and paste, making an index, etc.

A printed barcode module typically has a length on the order of 0.5 mm. The length of an edge of an envelope or sheet is on the order of about 200 mm. Using the previous examples with 16 bits per MSET module, an edge can contain about 6400 bits or 800 bytes. An error correction code, such as the Reed-Solomon error correction code for example, can enable accurate reading of the encoded edge. Even with 40 percent error correction, the edge can contain 480 bytes which is enough to encode a compression of most of the document text, or document metadata.

A page is typically 0.075 mm thick. A 1200 dpi scanner pixel is 0.021 mm, so a module on the edge of a page is over three pixels across. If the module length is 0.5 mm then it is 23 pixels long. The large number of pixels per module can help to assure accurate reading.

Referring also to FIG. 11, a system for reading a MSET encoded edge will be described. The system 74 generally comprises an excitation source 76, an imaging system 78, and at least one filter 80. In the embodiment shown, the excitation source 76 comprises an ultraviolet (UV) radiation source. However, any suitable excitation source could be provided. The filter is a narrow band filter, shown schematically in FIG. 11, which blocks all emissions from the information marking 44 on the MSET encoded edge other than the one that matches the band of the filter. The filter in this figure passes a band represented by a series of horizontal lines in the marking 44. Any MSET module that has horizontal lines passes through the filter and shows as white on the filtered image 82. All emissions are blocked from any MSET module that does not have emissions in the passband.

Creation of the information marking on a substrate generally comprises a method for encoding information comprising orienting a document with a side edge of the substrate of the document at least partially facing towards a printer; and printing the information marking on the side edge of the substrate by the printer, wherein the information marking comprises multi-spectral encoding tags. The information encoded in the information marking preferably corresponds to information contained in the document, such as printed on other sides of the substrate by another non-multi-spectral encoding printing for example.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A document comprising:
a substrate having a front side, a rear side and a perimeter side edge, wherein the perimeter side edge has a substantially smaller size than the front side and the rear side; and
an information marking printed on the perimeter side edge of the substrate, wherein the information marking comprises multi-spectral encoding tags adapted to be read in a direction towards the perimeter side edge.

2. A document as in claim 1 wherein the substrate comprises an envelope.

3. A document as in claim 1 wherein the substrate comprises a document file folder and the side edge is a fold in the file folder.

4. A document as in claim 1 wherein the information marking comprises:
a first information marking comprising first luminescent taggants having a first luminescence wavelength band; and
a second information marking comprising a second different luminescent taggant having a second different luminescence wavelength band, wherein the second luminescence wavelength band is spaced from the first luminescence wavelength band.

5. A document as in claim 4 wherein the second information marking is printed at least partially on the first information marking at an overlap location.

6. A document as in claim 4 wherein the first luminescence wavelength band of the first luminescent taggants comprises a narrow bandwidth of about 30 nm or less.

7. A document as in claim 4 wherein the first luminescent taggants comprise quantum dot particles.

8. A document as in claim 4 wherein the first luminescent taggants comprise rare earth nanoparticles.

9. A document as in claim 4 wherein the first marking comprises color ink comprising a first carrier and the first luminescent taggants.

10. A document as in claim 4 wherein the first information marking comprises invisible ink with a substantially transparent carrier and the first luminescent taggants.

11. A document as in claim 4 wherein the first information marking and the second information marking combine to form a unified spatial information visible in normal daylight.

12. A document as in claim 1 wherein the information marking comprises color ink comprising a carrier and a plurality of different luminescent taggants in the carrier, wherein the different luminescent taggants each comprises different spaced luminescence wavelength bandwidths, respectively.

13. A document as in claim 1 wherein the information marking comprises a plurality of different luminescent taggants arranged in adjacent areas to form a bar code of the different luminescent taggants along the side edge of the substrate.

14. A document container assembly comprising:
a document container comprising a bottom with a window section; and
a plurality of documents located in the document container, each document comprising:
a substrate having a side edge located against a top side of the bottom of the document container, and
an information marking printed on the side edge of the substrate, wherein the information marking comprises multi-spectral encoding tags,
wherein the documents are arranged in the document container such that the information markings of the plurality of documents can be read at a substantially same time through the window section.

15. A document container assembly as in claim 14 wherein the document container comprises a general mail tray shape with an open top.

16. A document container assembly as in claim 14 wherein the documents comprise mail pieces.

17. A document container assembly as in claim 16 wherein the information marking is selected from the group consisting of: postage value information, address destination information and sender information.

18. A document container assembly as in claim 16 wherein the document container comprises a hanging file folder.

19. A bound document comprising:
a plurality of document pages connected to each other, each page comprising a substrate and indicium printed on the substrate, wherein each substrate comprises a first side edge which combine to form a first side of the bound document when the bound document is in a closed configuration; and
information markings printed on the first side edges of the substrates, wherein the information markings comprises multi-spectral encoding tags.

20. A bound document as in claim 19 wherein each of the information markings comprise:
a first information marking comprising first luminescent taggants having a first luminescence wavelength band; and
a second information marking comprising a second different luminescent taggant having a second different luminescence wavelength band, wherein the second luminescence wavelength band is spaced from the first luminescence wavelength band.

21. A bound document as in claim 20 wherein the first luminescence wavelength band of the first luminescent taggants comprises a narrow bandwidth of about 30 nm or less.

22. A bound document as in claim 20 wherein the first luminescent taggants comprise quantum dot particles.

23. A bound document as in claim 20 wherein the first luminescent taggants comprise rare earth nanoparticles.

24. A bound document as in claim 20 wherein the first marking comprises color ink comprising a first carrier and the first luminescent taggants.

25. A bound document as in claim 24 wherein the first information marking comprises invisible ink with a substantially transparent carrier and the first luminescent taggants.

26. A bound document as in claim 19 wherein the information marking comprises color ink comprising a carrier and a plurality of different luminescent taggants in the carrier, wherein the different luminescent taggants comprise different spaced luminescence wavelength bandwidths, respectively.
